(19) United States
(12) Patent Application Publication
(10) Pub. No.: US 2016/0153561 A1
(43) Pub. Date: Jun. 2, 2016

(54) RADIAL SHAFT SEAL

(71) Applicants: NIDEC GPM GMBH, Auengrund / OT Merbelsrod (DE); VR AUTOMOTIVE DICHTUNGSSYSTEME GMBH, Auengrund / OT Crock (DE)

(72) Inventors: Andreas BLECHSCHMIDT, Zella-Mehlis (DE); Martin SCHAUB, Hildburghausen (DE)

(73) Assignees: NIDIAL GPM GmbH, Auengrund / OT Merbelsrod (DE); VR Automotive Dichtungssysteme GmbH, Auengrund / OT Crock (DE)

(21) Appl. No.: 14/901,418

(22) PCT Filed: Jun. 26, 2014
(86) PCT No.: PCT/DE2014/000326

§ 371 Date: Dec. 28, 2015

(30) Foreign Application Priority Data
Jun. 29, 2013 (DE) 10 2013 010 926.4

(51) Int. Cl. F16J 15/3232; F16J 15/3268; F16J 15/3252; F16J 15/322; F16J 15/324

(52) U.S. Cl. CPC F16J 15/3232; F16J 15/322; F16J 15/324; F16J 15/3252; F16J 15/3268

(57) ABSTRACT

A radial shaft seal for sealing a rotating shaft led out from a space filled with a fluid medium, for example for sealing the drive shaft of a coolant pump, minimizes wear, especially the starting wear acting upon the sealing lips in double lip sealing systems, and allows end-of-line motor tests with coolant pumps without cooling liquid for up to several hours without damages to the radial shaft seal. The radial shaft seal includes two sealing bodies, an outer lip element on the pressure side and an inner lip element on the atmosphere side, each having a sealing cylinder resting on the shaft or the sleeve, arranged in a sealing housing with a joined metal supporting body, the sealing cylinders having three adjoining sealing cylinder regions such that on each pressure side a conical inlet surface and opposite thereof on each negative pressure side a conical outlet surface are provided, in each case a cylindrical contact zone being present between the conical inlet surface and the conical outlet surface. A lubrication chamber is defined by the outer lip, the supporting body, the inner lip element having the inner lip and the shaft, or the sleeve and is sealed on all sides, a lubricant medium which is flowable at room temperature and which has a kinematic viscosity in the range of 5,000 mm²/s to 1.000 mm²/s at a residual excess pressure of 0.005 bar to 0.01 bar being arranged in the lubrication chamber.

The invention relates to a radial shaft seal for sealing a rotating shaft led out of a space to which a fluid medium is applied, having a seal housing, at least one ring-shaped sealing body disposed in the seal housing, which body lies against the shaft, forming a seal by means of a sealing lip, and at least one ring-shaped, metallic supporting body that positions the sealing body/bodies in the seal housing, to seal off an interior space filled with fluid, relative to an exterior space, preferably the atmosphere.

Areas of use of such shaft seals are machine construction, apparatus construction, and motor vehicle construction, such as, for example, sealing the drive shafts of coolant pumps with regard to thin, water-based cooling media having slightly lubricate additives.

Radial shaft seals for water pumps, having two sealing bodies spaced apart from one another, which have two sealing lips, in each instance, which lips lie against the shaft in line shape, forming a seal, are known from DE 10 2008 010 338 A and DE 10 2008 010 341 A.

It is characteristic for the two designs last mentioned that the two sealing bodies are configured in the same manner, in each instance, and therefore they can be produced in the same tool mold.

As compared with DE 10 2008 010 338 A, DE 10 2008 010 341 A has a collection space for leakage fluid, into which space a centrifuge element connected with the shaft to be sealed, in torque-proof manner, projects.

For all of these aforementioned designs, it is characteristic that the sealing lips of the sealing bodies, which lips lie against the shaft or against a shaft running sleeve disposed on the shaft, in line shape, are configured in “wedge shape,” i.e. that these narrow line surfaces of the sealing bodies, which are pressed against the shaft or against the shaft running sleeve in the operating state, are subject to great wear, wherein the sealing lips of the sealing membrane body adjacent to the interior space, which surfaces are most strongly confronted with a dirt load, wear out first, so that the sealing lips of the second sealing membrane body, which are disposed further to the outside, must then provide a seal against leakage that passes through the worn lips.

In other words, in these designs the subsequent “second seal” then takes on the task of the “first seal” after the latter has worn out.

However, since the sealing lips of the second sealing membrane body “run” on the shaft or the shaft running sleeve in non-cooled manner, they are necessarily subject to increased wear and become hard after a short period of use.

As a result, they lose the sealing tension that is necessarily required to prevent leakage, and can no longer completely fulfill their task as seals after a certain period of use (i.e. when they are actually needed), so that the leakage losses of these shaft seals clearly increase over the period of operation.

In DE 101 41 138 C2, filed by the applicant, a further radial shaft seal having two sealing lips disposed spaced apart from one another, set at a slant counter to the pressure direction, lying against the shaft in line shape, forming a seal, is previously described, which lips are disposed on two sealing bodies disposed one inside the other, wherein a supporting body is disposed between the two sealing bodies, which supporting body supports the sealing membrane adjacent to the interior space on its side facing away from the inner chamber. In these designs, a high temperature grease was filled into the space between the two sealing membranes.

From WO 002007101429 A1, a further solution of the applicant for a radial shaft seal is known, having two sealing lips disposed spaced apart from one another, set at a slant counter to the pressure direction, lying against the shaft in line shape, forming a seal, in which seal the space between the two sealing membranes was also filled with a high temperature grease.

The fact that according to the solution presented in DE 101 41 138 C2 as well as in WO 002007101429 A1, the space between the two sealing membranes was filled with a high temperature grease had the result, in combination with the sealing lip geometries present in these two designs, that the high temperature grease “sticks” to the walls, in viscous manner, with a dropping point of approximately 200° C., in the starting state of the coolant pump, and cannot bring about any lubrication of the wedge-shaped sealing lips, which lie against the running sleeve in line shape, with a low press down force.

Because of the absence of an active interior pressure in the inner chamber, as well as the absence of another active press down force for pressing the lip, which faces the “dry space,” against the shaft, these lips tend to lose contact with the shaft, and therefore even a thinner lubricant would very rapidly escape from the space between the two sealing lips.

Because of the “absence” of lubricant, as described, very great wear occurs on the lip that faces the “dry space.”

Furthermore, solutions are known from the state of the art, in which an outer elastomer lip is combined with a lip that lies underneath, composed of plastic having a high PTFE proportion, wherein a small amount of commercially available lubricant grease is introduced between the two lips; in this connection, the grease in turn serves for short term lubrication of the elastomer lip.

In dry long-term runs without a cooling medium, over several hours, it turned out, however, that the plastic lip, which lies on the shaft with a broad area in these designs, wears due to the introduction of friction energy. The commercially available lubricant grease introduced between the two lips by no means demonstrates the desired effects of improving running.

In the case of other lip geometries, with large area sealing lips, i.e. lips that lie against the shaft with a large area, as these DE 917 942 A, DE 977 331 A, U.S. Pat. No. 2,467,210 A, U.S. Pat. No. 2,630,357 A, U.S. Pat. No. 5,303,935 A, or also DE 10 2010 0 44 427 A1, for example, this increased wear occurs after a relatively short period of use, in combination with weakly lubricating media (cooling fluids), in the edge region of the sealing lips that are pressed against the shaft over a large area, because mixed friction and therefore increased wear occur immediately upon startup, so that even in the double-lip sealing systems, with sealing lips that lie against the shaft or the shaft sleeve over a large area, all of the disadvantages already described above occur; these particularly consist in that during dry-running operation, both lips are subject to very great wear, and in standard operation with cooling medium, the inner lip, i.e. the lip facing away from the cooling medium, is subject to very great wear after startup of the pump.

This starting wear, which occurs in the cooling circuit after startup of the pump, can lead to extreme damage of the lip seal and to its premature failure.

All the solutions previously described in the state of the art are unable to solve the basic problem of increased starting wear during startup of the cooling circuit.

The problematical tribology that occurs in this connection always leads to failure of the sealing lip that faces the water pump bearing, after a relatively short running time, because it works without lubrication, with dry friction, in the starting phase, and thereby the temperature and wear increase greatly.

The cause of this great starting wear can only be explained in that the inner lip generally runs dry, under normal operating conditions, until cooling medium penetrates through the outer lip to the inner lip and then “lubricates”/“could lubricate” the latter.

For the elastomer sealing lips used in the previously mentioned designs, as well as the PTFE-based plastic sealing lips used there, this time period of dry running at a high speed of rotation and with the absence of cooling fluid, with tribologically disadvantageous mixed friction/dry friction, is so long that damage, i.e. “burning” due to mixed-friction wear or dry-friction wear takes place after a relatively short running time, which damage results in complete destruction of the inner lip, so that during further operation, only the outer lip can still take on a sealing function.

However, “end of line” engine tests, i.e. engine tests over up to several hours with coolant pumps without cooling fluid, result in complete destruction of the sealing lips in all the previously mentioned designs of radial shaft seals used in coolant pumps.

Further disadvantages of the designs described in the state of the art furthermore result from the great number of individual components of which the radial shaft seals previously described in the state of the art consist, as well as from the production precision that results for their functionally correct production and assembly, which clearly increase the costs connected with production and assembly.

A further problem that currently exists in the use of radial shaft seals in cooling systems of motor vehicles consists in that first filling of the cooling systems takes place in such a manner that the cooling system is evacuated by means of a suction pump, tested for leaks, and subsequently filled with coolant, in air-free manner, utilizing the partial vacuum that has been produced.

In this connection, the wear phenomena on the sealing lips, as described above, do not have any effects on this first filling, of course.

However, since many workshops already perform filling in air-free manner, with a partial vacuum, within the scope of repair or maintenance work, air can get into the cooling circuit by way of leaky, worn sealing lips, with the resulting disadvantages.

The task of the invention therefore consists in developing a new type of radial shaft seal for sealing a shaft led out of a space filled with a fluid medium, relative to the atmosphere, which eliminates the aforementioned disadvantages of the state of the art even in coolant pumps, with the use of thin, liquid, water-based coolants having slightly lubricating additives, allows even “end of line” engine tests with coolant pumps without cooling fluid, over up to several hours, without damage to the radial shaft seal, and clearly minimizes wear when the shaft is rotating, particularly starting wear, of the sealing lips in double-lip sealing systems, as compared with the current state of the art, clearly lowers leakage losses as compared with the state of the art, furthermore reliably prevents leakage during shut-down, at the same time can be produced and assembled in simple manner, in terms of production technology, thereby clearly reduces the production and assembly costs, and thereby increases not only the useful lifetime but also reliability so clearly that even after an extended period of use, “air-free” vacuum filling of coolant pumps is still possible.

According to the invention, this task is accomplished by a radial shaft seal according to the characteristics of the main claim of the invention.

Advantageous embodiments, details, and characteristics of the invention are evident from the dependent claims as well as from the following description of the exemplary embodiments according to the invention, in combination with the drawings relating to the solution according to the invention.

In the following, the invention will be explained in greater detail, using an exemplary embodiment, in combination with four figures.

These show:

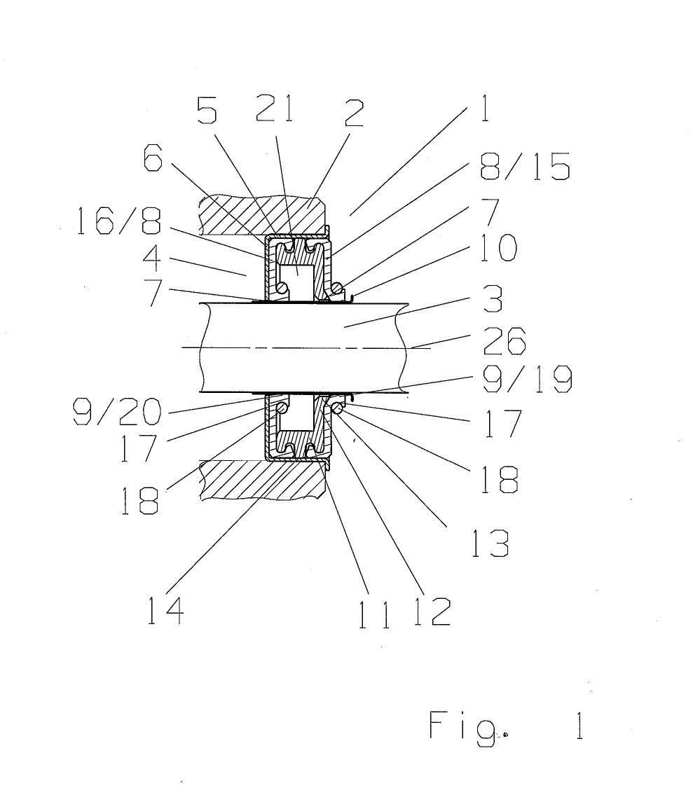

FIG. 1: the radial shaft seal according to the invention, in the installed state, in a side view, in section, after final assembly, i.e. after installation into a coolant pump, for example;

FIG. 2: the radial shaft seal according to the invention, with a running sleeve 10 inserted, before final assembly, in a top view;

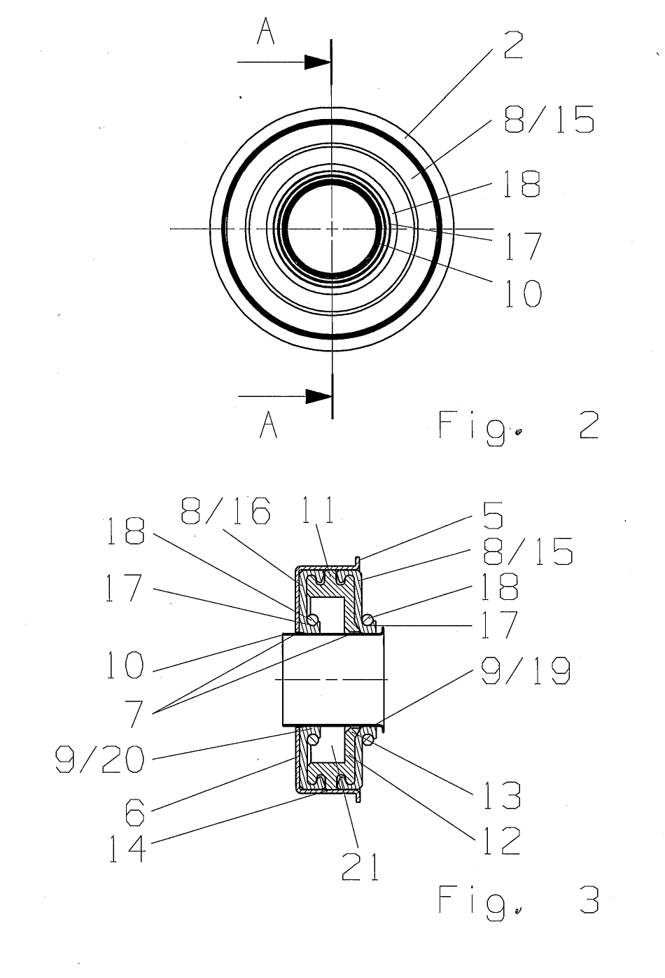

FIG. 3: the radial shaft seal according to the invention, with a running sleeve 10 inserted, before final assembly, according to FIG. 2, in a side view, in section at A-A;

FIG. 4: the radial shaft seal according to the invention, without a running sleeve 10, before final assembly, in a side view, in section;

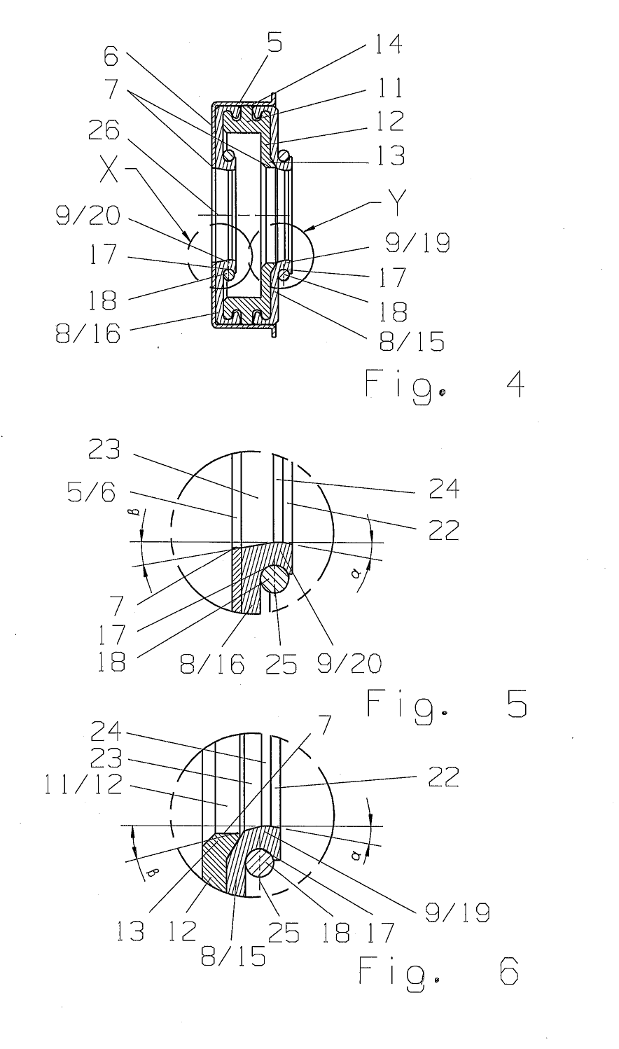

FIG. 5: the detail X of the radial shaft seal according to the invention according to FIG. 4, with a representation of the inner lip 20 according to the invention;

FIG. 6: the detail Y of the radial shaft seal according to the invention according to FIG. 4, with a representation of the outer lip 19 according to the invention.

In FIG. 1, the radial shaft seal according to the invention is shown in the installed state in a coolant pump, i.e. after final assembly.

This FIG. 1 shows the radial shaft seal according to the invention for sealing a rotating shaft 3 led out of pressure space 1 of a housing 2 that defines a working space filled with a fluid medium, relative to an exterior space 4, preferably the atmosphere.

A metallic seal housing 5 having a rear wall 6 is disposed in a bore of the housing 2 that defines a working space.

A shaft passage bore 7 is situated in this rear wall 6. Two ring-shaped sealing bodies 8 that consist of elastic material are disposed in the seal housing 5, which bodies lie directly against a running sleeve 10 disposed on the shaft 3, in torque-proof manner, with sealing lips 9 disposed on these sealing bodies 8, wherein the two sealing bodies 8 are simultaneously positioned in the seal housing 5 by means of a ring-shaped, metallic supporting body 11.

It is essential to the invention that a contact plate 12 having a shaft passage bore 7 is disposed on the metallic supporting body 11 to be positioned in the seal housing 5, and that the outer edge 14 of the supporting body 11 to be positioned in the seal housing 5 has an excess dimension relative to the inner radius of the seal housing 5, and that the supporting body 11 is therefore joined to the seal housing 5 with press fit.

This press fit of the metallic supporting body 11 in the metallic seal housing 5 guarantees secure fit of the supporting body 11 in the seal housing 5 even during temperature changes.

It is also characteristic, in this connection, that two sealing bodies 8, i.e. an outer lip element 15 on the pressure side and an inner lip element 16 on the atmosphere side, are positioned on the supporting body 11, in such a manner that the outer lip element 15 lies against the contact plate 12 of the supporting body 11, and the inner lip element 16 lies against the rear wall 6 of the seal housing 5, with their full area, so that even under great pressure stress, both sealing bodies 8 are simultaneously positioned in the seal housing 5, in a stable position.

In this regard, it is also essential to the invention that a sealing cylinder in the form of a cylindrical sealing lip 9 having an outer groove 17 disposed on the outside circumference of the sealing cylinder is disposed not only on the outer lip element 15 but also on the inner lip element 16, in the region that lies against the shaft 3 or the running sleeve 10, in each instance, which cylinder is always only formed outward toward the pressure side, wherein a helical spring 18 is disposed in these outer grooves 17 of the sealing lips 9, in each instance, which spring presses not only the sealing cylinder of the outer lip element 15, the outer lip 19, but also the sealing cylinder of the inner lip element 16, the inner lip 20, against the shaft 3 or the running sleeve 10 disposed on the shaft 3 in torque-proof manner, so that an optimal press-down pressure is always guaranteed between the respective sealing cylinder and the shaft 3 or the running sleeve 10 when the shaft 3 is rotating, which, among other things, also minimizes leakage losses, and, last but not least, prevents leakage during shut-down.

However, it is also essential that a lubrication chamber 21 that is sealed off on all sides is formed by the outer lip 19, the supporting body 11, the inner lip element 16 with the inner lip 20, and the shaft 3 or the running sleeve 10, wherein the sealing cylinders of the sealing lips 9 that lie against the shaft 3 or against the running sleeve 10, in other words not only the sealing cylinder of the outer lip 19 but also the sealing cylinder of the inner lip 20, are divided into three sealing cylinder regions that lie next to one another, in such a manner that an entry cone surface 22 is always disposed, in each instance, on the pressure side of the outer lip 19, and, on the pressure side, on the inner lip 20, and, opposite to this, an exit cone surface 23 is always disposed on the partial vacuum side of the outer lip 19, and, on the partial vacuum side, on the inner lip 20, and a cylindrical contact zone 24 is disposed between these, and that the central groove axis 25 of the outer groove 17 is disposed in the transition region from the contact zone 24 to the exit cone surface 23.

As a result, a precisely defined pressure progression can be guaranteed over the entire working width of the respective sealing lip 9 that enters into an active connection with the shaft 3 or the running sleeve 10.

This radial shaft seal according to the invention, which has just been described in connection with FIG. 1, is shown in a top view in FIG. 2, with the running sleeve 10 inserted, i.e. before final assembly.

FIG. 3 shows this radial shaft seal according to the invention according to FIG. 2 in a side view, in section at A-A.

In FIG. 4, the radial shaft seal according to the invention is now shown in a side view without a running sleeve 10, in section, to illustrate the configuration of the sealing lips 9 according to the invention.

FIG. 5 shows the detail X of the radial shaft seal according to the invention according to FIG. 4, with a representation of the inner lip 20 according to the invention, and in FIG. 6, the detail Y of the radial shaft seal according to the invention, according to FIG. 4, with the outer lip 19 according to the invention, is shown.

In this regard, FIGS. 5 and 6, in particular, show the configuration of the sealing lips according to the invention, which are characterized in that the entry cone surface 22 has an entry cone having a pressure entry angle α, relative to the shaft axis 26, which angle lies in the range from 1° to 10°, according to the invention.

It is essential to the invention, as is also shown in FIGS. 5 and 6, that the cylinder wall of the contact zone 24 runs with rotation symmetry relative to the shaft axis 26, and that the exit cone surface 23 has an exit cone having a pressure exit angle β from 1° to 15°, relative to the shaft axis 26.

The entry cone surface 22 of the outer lip 19, according to the invention, brings about a pressure buildup in the region toward the contact zone 24 in the operating state, i.e. as shown in FIG. 1, under working pressure in the pressure space 1, which guarantees a minimal working sealing gap under spring pressure stress of the helical spring 18, so that at minimal leakage losses, minimization of the mixed-friction region is implemented by means of the solution according to the invention, by way of the exit cone surface 23, with a simultaneous pressure drop toward to the lubrication chamber 21.

The almost analogous structure of the inner lip 20 achieves the effects described in connection with the outer lip 19, in analogous manner, merely at a reduced pressure level, i.e. from the inside pressure in the lubrication chamber to the atmospheric pressure in the exterior space 4.

It is also essential to the invention that the supporting body 11 has a ring-shaped outer lip contact crosspiece 13 that is angled away on the pressure side, in the region of the shaft passage bore 7, which crosspiece prevents extrusion of the elastic material of the outer lip 19, which material is under stress from the working pressure, into the gap between the shaft passage bore 7 of the supporting body 11 and the shaft 3 or running sleeve 10.

Furthermore, it is essential that a lubrication medium that is capable of flow at room temperature, having a kinematic viscosity in the range of 5,000 mm²/s to 1,000 mm²/s, is disposed in the entire lubrication chamber 21 of the radial shaft seal according to the invention, under a residual excess pressure after filling of 0.005 bar to 0.01 bar, i.e. after filling, the lubrication chamber is always completely filled, and the lubrication medium stands under slight excess pressure in the lubrication chamber.

In the present exemplary embodiment, the volume of the lubrication chamber 21 amounts to approximately 1 cm³, at a seal diameter of 30 mm.

The combination of the arrangement, according to the invention, of the sealing lip geometries, according to the invention, with the lubrication medium that is disposed, according to the invention, in the lubrication chamber 21 according to the invention, brings about such a surprising tribological effect, according to the invention, that even “end of line” engine tests with coolant pumps without cooling fluid, i.e. dry-run tests of the radial shaft seal according to the invention, at up to 4000 rpm, over a test period of 12 hours, did not result in prior damage of the sealing lips that impaired their function.

In this connection, under these extreme conditions, the previously described optimal sealing function, according to the invention, with the most minimal wear of the sealing lips, was surprisingly only achieved in combination with the flat cone angles at the lip geometry, according to the invention.

In long-term tests conducted over approximately 7,300 h, the radial shaft seal according to the invention, in combination with use in coolant pumps, furthermore continued to demonstrate astounding leakage behavior, in which phases with very slight but still measurable leakage recurrently alternated with phases of non-measurable leakage.

Because of this recurring effect of different leakage phases, it is certainly possible to speak of “self-optimization effects” in the sealing behavior, although it has not yet been possible to establish any technical reasons for this.

In practical tests with the radial shaft seals according to the invention, integrated into coolant pumps, it was clearly confirmed that even “end of line” engine tests with coolant pumps without cooling fluid are possible without problems, over several hours, without damage to the radial shaft seal according to the invention.

Therefore the radial shaft seal according to the invention guarantees great reliability and a long useful lifetime even under the most extreme conditions.

It is also advantageous if the radial shaft seal, as shown in FIGS. 2 and 3, is pre-assembled with a running sleeve 10, and, in this regard, the lubrication medium according to the invention is already disposed in the lubrication chamber 21.

The radial shaft seals according to the invention pre-assembled in this manner allow simple installation, for example into coolant pumps, and, by means of the use of precision machine running sleeves 10, for example composed of stainless steel, guarantee minimization of the wear of the sealing lips 9, with simultaneous optimal lubrication of the sealing lips 9 by the lubrication medium disposed in the lubrication chamber 21, according to the invention, which medium furthermore simultaneously continuously cools the sealing lips, which consist of rubber-elastic material, and also continuously “maintains”/lubricates them during operation, and thereby prevents the rubber of the sealing lips from hardening and “digging into” the “running region” of the shaft 3 or running sleeve 10, for example, and thereby wearing out.

At the same time, the radial shaft seal pre-assembled in this manner increases reliability with the working pressure in the lubrication chamber 21, according to the invention, and, at the same time, brings about a clear reduction in assembly costs during production, for example when using the radial shaft seal according to the invention in coolant pumps.

With the solution according to the invention, it has been made possible to develop a new type of radial shaft seal for sealing a rotating shaft led out of a space filled with a fluid medium, relative to the atmosphere, which seal eliminates the disadvantages of the state of the art even in coolant pumps, with the use of thin, liquid, water-based coolants having slightly lubricating additives, and allows even “end of line” engine tests with coolant pumps without cooling fluid, and radial shaft seals according to the invention integrated into the coolant pumps, over up to several hours, without damage to the radial shaft seals, and clearly minimizes wear of the sealing lips in double-lip sealing systems when the shaft is rotating, as compared with the present state of the art, clearly lowers leakage losses as compared with the state of the art, furthermore reliably prevents leakage during shut-down, at the same time can be produced and assembled in simple manner, in terms of production technology, and thereby clearly reduces production and assembly costs during final production, and, at the same time, increases not only the useful lifetime but also reliability so clearly that “air-free” vacuum filling is still possible even after an extended period of use.

### REFERENCE SYMBOL LIST

1 pressure space
2 housing that defines a working space
3 shaft
4 exterior space
5 seal housing
6 rear wall
7 shaft passage bore
8 sealing body
9 sealing lip
10 running sleeve
11 supporting body
12 contact plate
13 outer lip contact crosspiece
14 outer edge
15 outer lip element
16 inner lip element
17 outer groove
18 helical spring
19 outer lip
20 inner lip
21 lubrication chamber
22 entry cone surface
23 exit cone surface
24 contact zone
25 central groove axis
26 shaft axis
α pressure entry angle
β pressure exit angle

1. Radial shaft seal for sealing a rotating shaft (3) led out of a pressure space (1) of a housing (2) that defines a working space, filled with a fluid medium, relative to an exterior space (4), such as the atmosphere, having a metallic seal housing (5) disposed in a bore of the housing (2) that defines a working space, with a rear wall (6) and a shaft passage bore (7) disposed in this rear wall (6), wherein multiple ring-shaped sealing bodies (8) comprising elastic material are disposed in the seal housing (5), which lies/lie directly against a shaft (3) or a running sleeve (10) disposed on the shaft (3), in torque-proof manner, with the sealing lip(s) (9) disposed on this/these sealing body/bodies (8), wherein the sealing body/bodies (8) is/are positioned in the seal housing (5) by means of a ring-shaped metallic supporting body (11), wherein
a contact plate (12) having a shaft passage bore (7) is disposed on the metallic supporting body (11) to be positioned in the seal housing (5), wherein the outer edge (14) of the supporting body (11) to be positioned in the seal housing (5) has an excess dimension relative to the inner radius of the seal housing (5), and wherein the supporting body (11) is therefore joined to the seal housing (5) with press fit, and
wherein two sealing bodies (8), i.e. an outer lip element (15) on the pressure side and an inner lip element (16) on the atmosphere side, are positioned on the supporting body (11), in such a manner that the outer lip element (15) lies against the contact plate (12) and the outer lip contact crosspiece (13) of the supporting body (11), and the inner lip element (16) lies against the rear wall (6) of the seal housing (5), with their full area, and
wherein a sealing cylinder in the form of a cylindrical sealing lip (9) having an outer groove (17) disposed on the outside circumference of the sealing cylinder is disposed not only on the outer lip element (15) but also on the inner lip element (16), in the region that lies against the shaft (3) or the running sleeve (10), in each instance, which cylinder is always formed outward only toward the pressure side, wherein a helical spring (18) is disposed in these outer grooves (17), in each instance, which spring presses not only the sealing cylinder of the outer lip element (15), the outer lip (19), but also the sealing cylinder of the inner lip element (16), the inner lip (20), against the shaft (3) or the running sleeve (10) disposed on the shaft (3) in torque-proof manner,
wherein a lubrication chamber (21) that is sealed off on all sides is formed by the outer lip (19), the supporting body (11), the inner lip element (16) with the inner lip (20), and the shaft (3) or the running sleeve (10), wherein the sealing cylinders of the sealing lips (9) that lie against the shaft (3) or against the running sleeve (10), in other words not only the sealing cylinder of the outer lip (19) but also the sealing cylinder of the inner lip (20), are divided into three sealing cylinder regions that lie next to one another, in such a manner that an entry cone surface (22) is always disposed, in each instance, on the pressure side of the outer lip (19), and, on the pressure side, on the inner lip (20), and, opposite to this, an exit cone surface (23) is always disposed on the partial vacuum side of the outer lip (19), and, on the partial vacuum side, on the inner lip (20), and a cylindrical contact zone (24) is disposed between these, wherein the central groove axis (25) of the outer groove (17) is disposed in the transition region from the contact zone (24) to the exit cone surface (23), and
wherein the entry cone surface (22) has an entry cone having a pressure entry angle (α), relative to the shaft axis (26), from 1° to 10°, the cylinder wall of the contact zone (24) runs with rotation symmetry relative to the shaft axis (26), and the exit cone surface (23) has an exit cone having a pressure exit angle (β) from 1° to 15°, relative to the shaft axis (26), and
wherein a lubrication medium that is capable of flow at room temperature, having a kinematic viscosity in the range of 5,000 mm²/s to 1,000 mm²/s, is disposed in the entire lubrication chamber (21) of the radial shaft seal according to the invention, under a residual excess pressure after filling of 0.005 bar to 0.01 bar.

2. Radial shaft seal according to claim 1, wherein the supporting body (11) has a ring-shaped outer lip contact crosspiece (13) angled away on the pressure side, in the region of the shaft passage bore (7).
